(19) United States
(12) Patent Application Publication
(10) Pub. No.: US 2014/0350441 A1
(43) Pub. Date: Nov. 27, 2014

(54) VIBRATORY NEURAL STIMULATION

(71) Applicant: IMAN SHAFIELOO, Waterloo (CA)

(72) Inventor: IMAN SHAFIELOO, Waterloo (CA)

(21) Appl. No.: 13/902,917

(22) Filed: May 27, 2013

(51) Int. Cl. A61H 23/02

(52) U.S. Cl. CPC A61H 23/02; A61H 2201/5097
USPC 601/48

(57) ABSTRACT

A vibratory neural stimulation (VNS) system is provided to help relieve pain by applying preprogrammed or user defined patterns to the region having pain. The VNS system comprises of plurality of miniature vibration disks installed in a flexible material forming a vibration mesh. A programmable control unit (PCU) controls the vibration frequency and amplitude, and the period of activation of each vibrator. A user can search for the more effective vibration pattern to relieve his or her pain.

### RELATED APPLICATION

The present invention claims the priority date of the U.S. Provisional Patent No. U.S. 61/669,149 filed Jul. 17, 2012.

### FIELD OF THE INVENTION

The present invention relates to a programmable vibration mesh for neural stimulation.

### BACKGROUND OF THE INVENTION

Headaches are attributable to many factors. Tension, stress, concerns about business or family problems, all cause headaches. Eye strain, sinuses, colds and flu can also cause headaches as well as overexposure to the sun, excessive consumption of alcohol, loud noises and high air or water pressure. Headaches can occur for several hours or last for many days, e.g. migraine headaches.

Presently, there are various methods to relieve pains and headaches. One being pharmaceutical headache and pain relievers. Alternatively, special devices and methods are developed to relieve pains and headaches, some of the more common ones are described below.

The more conventional non-pharmaceutical method of relieving pain is through massage and vibration therapies, as well as acupressure. Massage therapy is the art of manipulation of muscles and connective tissues to enhance function and aid in the healing process. Massage therapy relives pain from musculoskeletal injuries and other causes of pain, and rehabilitates sports injuries. Furthermore, massage has been shown to enhances relaxation, and reduce stress, anxiety and subclinical depression. It is also shown to temporarily reduce blood pressure, and heart rate.

Acupressure involves applying physical pressure against specific parts of the body to achieve some degree of treatment or pain relief. However, these devices require an attending therapist during treatment to be effective.

Electric stimulation is another method to relive pain, in which pulses of electric energy at low current levels are applied to the parts of the body that emanate pain. To apply an electric stimulus the prior art teaches the use of TENS (Transcutaneous Electrical Nerve Stimulation) devices. TENS devices deliver electric bursts through the skin to cutaneous (surface) and afferent (deep) nerves to control pain. TENS are able to stimulate a specific nerve to ease a specific point of pain.

Another method of pain relieve is through use of repetitive transcranial magnetic stimulation (TMS) to stimulate a brain cortex group of neurons. The repetitive transcranial magnetic stimulation is a method to generate a weak magnetic field and electric currents in a brain cortex neuron using a principle of an electromagnetic induction by instantaneously passing a current through a coil and stimulate the brain cortex neuron noninvasively. TMS is delivered by passing a brief (200 microsecond), strong (10,000 volts, 6,000 amps) electrical current through a coil of wire (a TMS stimulator) placed adjacent to the head. The passage of electrical current induces a strong (2 Tesla) magnetic field which, in turn, induces electrical currents in nearby tissues. In the case of nerve cells, if the induced current is sufficiently intense and properly oriented, it will result in synchronized depolarization of a localized group of neurons (i.e., neuronal “firing”).

The neural system of a human body is so complex that it is yet not possible to control specific region that generated pain. A truly important challenge in neuroscience is mapping and analyzing spatiotemporal patterns of the activity of large populations of neurons which are believed to be responsible for processing information in the human brain. It is currently believed that the brain can be perceived as a non-linear coupled oscillating system in which different areas contribute at the same time in different processes. The current device utilizes this nonlinear oscillator concept of the brain to stimulate the nerve system in the region of pain source. By providing a vibration pattern that substantially resonates in the region of pain, the neurons in that region can be manipulated reducing the perception of pain.

### SUMMARY OF THE INVENTION

The present invention relates to a programmable vibration mesh for vibratory neural stimulation (VNS). This device applies a patterned vibration to a desired region of the human body. This system comprises of a grid of multiple vibration disks installed throughout a resilient material and a programmable control unit (PCU) and a user interface in form of software on PC to control the vibration of each of the vibrators. The later may be installed in a hand held device or an android phone/iPhone, for ease of use, and wired or wirelessly connected to the vibrator mesh.

Described herein are methods, devices and systems for controlling the vibration of plurality of vibrators located at pain generating regions of a body. The vibration may be performed at fixed, random, or mixed fixed and random intervals, and/or at different pulse rates. In general, the methods described herein include methods of stimulating from multiple vibrators so that total energy of vibration may resonantly stimulate and alter firing of neurons in the region of pain. The methods further include controlling the timing, rate, and power of each vibrator in an array of vibrators to achieve effective pain relief.

Application of a plurality of vibrations to a part of a body generates a nonlinear oscillation on the region of pain. This nonlinear couple vibration can be adjusted to resonate with a specific nerve structure of an individual. Once a substantially resonance pattern is obtained, the pain should reduce. The pattern will be selected to match the natural vibration mode in the vicinity of the pain region. The natural vibration mode is obtained by trial and error using from a large number of vibration patterns provided by the present device. A variety of vibration patters can be used to find the most effective pattern for the individual. The pattern not only includes the order of activating each vibrator but also its frequency and amplitude.

The aforementioned objectives of the present invention are attained by a programmable vibration mesh for vibratory neural stimulation having a plurality of vibration elements and several accessories. Other objectives, advantages and novel features of the present invention will become readily apparent from the following drawings and detailed description of preferred embodiments.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows the vibratory neural stimulation (VNS) in the form of a cap with possible power options (USB, battery and power adaptor);

FIG. 2 shows two different miniature DC motors used as vibrators;

FIG. 3 shows (a) cable connection to computer, (b) wireless connection to computer or handheld devise like mobile;

FIG. 4 shows the vibrators and examples of vibration patters: (a) vibration pattern for all vibrators, (b) a user defined pattern of vibration;

FIG. 5 shows the electrical connection for the vibration mesh that is laid down inside a cap;

FIG. 6 shows schematic flow chart for a Programmable Control Unit (PCU);

FIG. 7 shows a preprogrammed pattern designed to apply to a pain region to relieve pain;

FIG. 8 shows back pain patch having a VNS system with a preprogrammed vibration pattern;

FIG. 9 shows the preprogrammed vibration for a VNS system starring from the no pain area and slowing moving towards the pain area;

FIG. 10 shows plurality of simple vibration patterns and related intensity diagrams;

FIG. 11 shows plurality of complicated vibration patterns and related diagrams;

FIG. 12 shows a VNS knee pad: (a) VNS knee pad with small vibrators, (b) VNS knee pad worn by a user;

FIG. 13 shows a VNS ankle brace: (a) VNS ankle brace with small vibrators, (b) VNS ankle brace worn by a user;

FIG. 14 shows a VNS wrist pad: (a) VNS wrist pad with small vibrators, (b) VNS wrist pad worn by a user;

FIG. 15 shows VNS facial mask with small vibrators;

FIG. 16 shows VNS insole with small vibrators;

FIG. 17 shows VNS glasses with small vibrators for eyes and temple stimulation

FIG. 18 shows VNS cushion pad with a controller.

### DETAILED DESCRIPTION OF PREFERRED EMBODIMENTS

The present device is a programmable vibratory neural stimulator (PVNS) comprising of plurality of small vibrators compactly installed in a flexible material to be worn or attached to a part of a body. The frequency, amplitude, and the operation time of each vibrator are controlled individually. Therefore, any specific pattern of vibration can be generated.

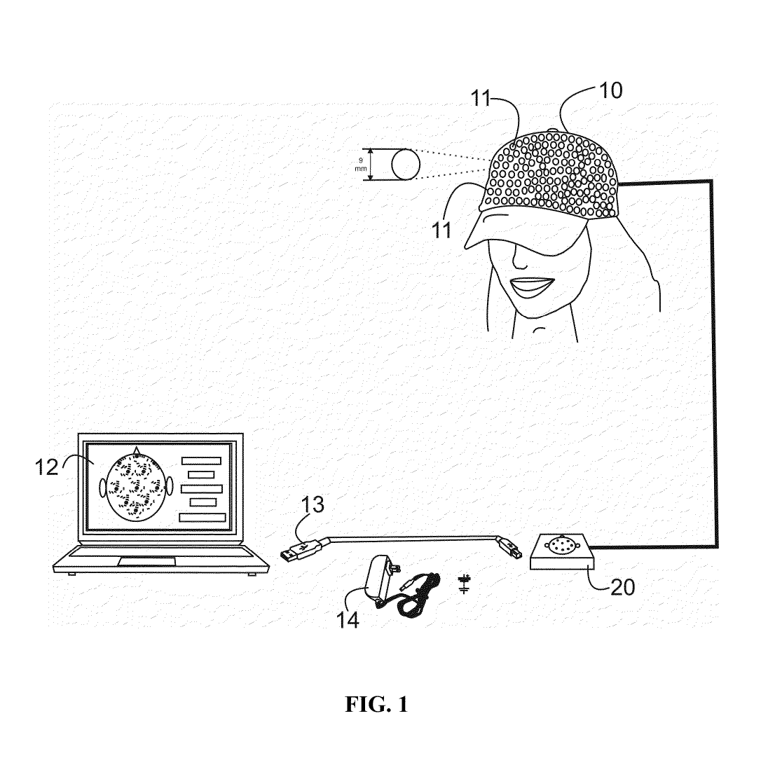

A VNS device and its application are described for a cap; however, the same system can be used for other outfits and accessories. FIG. 1 shows a cap 10 with a built in mesh of vibration disks 11 (miniature DC motors) on the inside surface of the cap 10, a Programmable Control Unit (PCU) 20 and a user interface in form of software on PC 12, hand held device or android phone/iPhone as well as optional wireless unit. FIG. 1 shows the VNS with possible power options (USB, battery and power adaptor 14). The maximum number of vibration nodes is defined by the inner surface area of the cap 10 and the size of each vibrator.

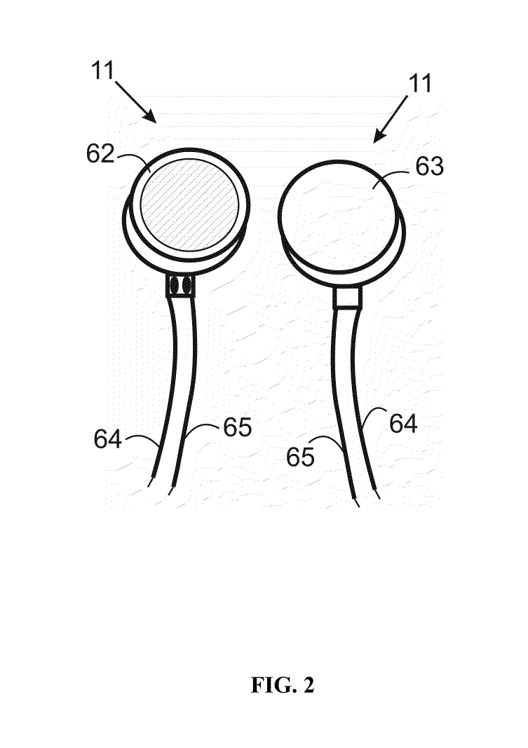

FIG. 2 shows a flat-type direct current vibration motor used in the present device. The vibrator 11 comprising of a cylindrical body having two substantially flat surfaces 62, 63. The vibrator motor 11 having wires 64 and 65 to connect to the system grid. There are a variety of miniature vibrators, for instance a motor in which a rotor has an eccentric structure which causes circumferential direction of the rotation. Such small vibrators are commonly used in mobile phones and are known to persons skilled in the art. One important character of the vibrators in the present device is that their amplitude has to be small enough that it does not provide pressure sensation. This type of vibrator is distinguished from the larger amplitude vibrators used for massage and muscle relaxation.

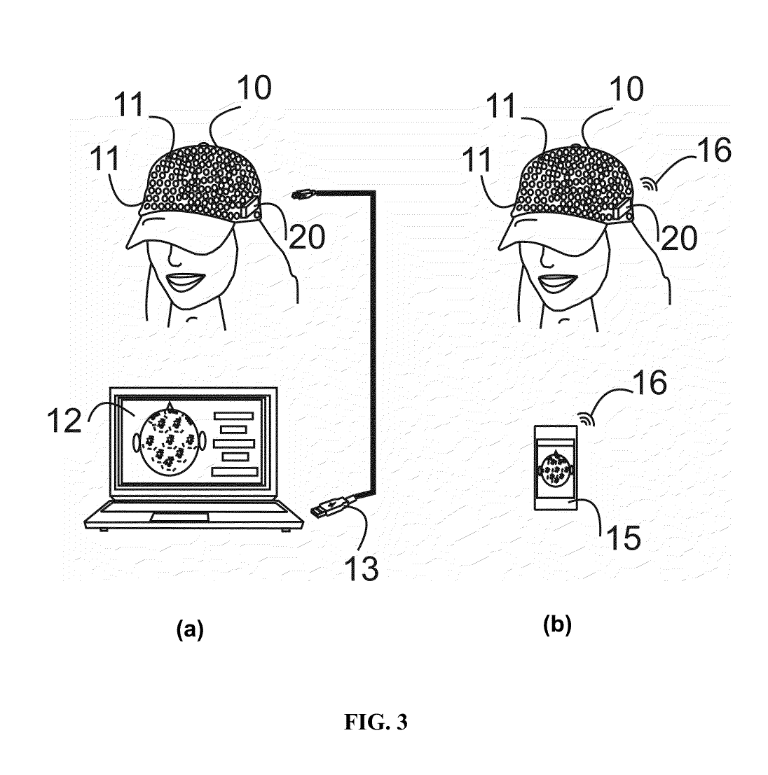

FIG. 3 shows a VNS installed inside a cap. A user interface in the form of software on a PC 12, a hand held device 15 or an android phone/iPhone 15 are shown in FIGS. 3(a) and 3(b). The box 20 attached to the cap 10 represents the PCU. Miniature DC motors 11 (vibration disks 11) are installed inside the cap in an array form creating a mesh of vibration nodes. The PCU 20 is connected to a PC 12 by USB connection 13 or through a mobile phone 15 with Wi-Fi or Bluetooth connection. 16. Acceleration, duration of vibration and frequency of vibration for each vibration node is controlled by the PCU 20.

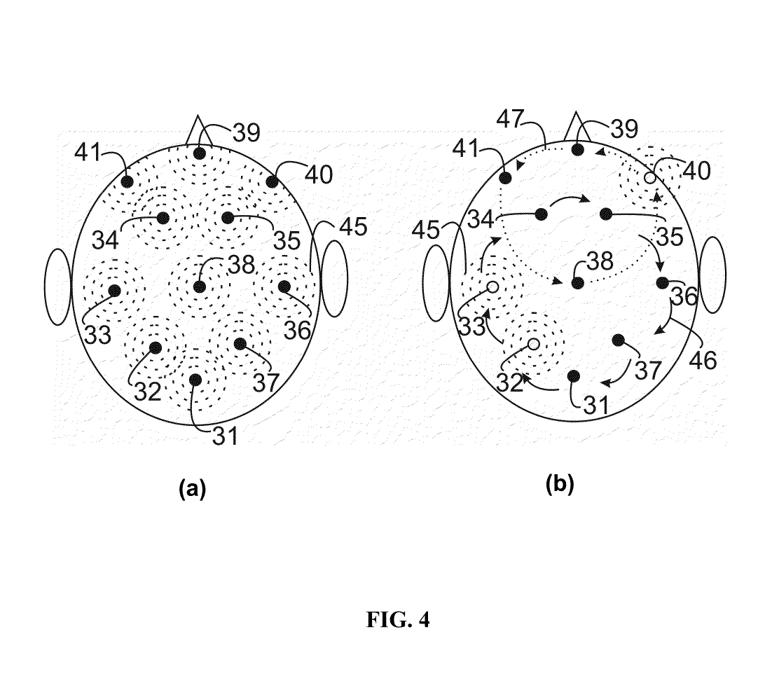

According to FIG. 4 different patterns of vibration can be provided to a user. The PCU controls vibration of each of the vibrator 31-41. All vibrators 31-41 can vibrate simultaneously or vibrate with a specific pattern. The dot lines 45 in FIG. 4 represent vibration patterns of each vibrator 31-41 and arrows 46 represent the direction of the movement of the vibration for the first group of vibrators 31-37 and arrows 47 represent the direction of the movement of the vibration for the second group of vibrators 38-41.

The present VNS system in the form of a cap can be worn by a user for an extended period of time to relieve headache, anxiety and stress. Patterns of head massage can be personalized based on individual's need.

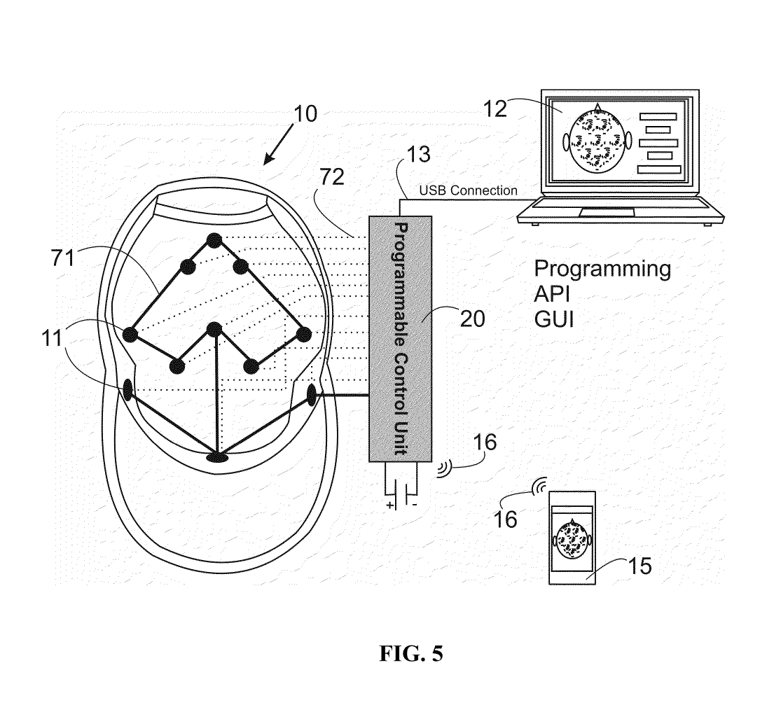

The user interface used in the present device is a software/program which allows a user to program the mesh with the desired patterns. The user interface may include a Graphic User Interface (GUI) on a PC, a hand held device or an android phone/iPhone. The user program could be uploaded onto the PCU via USB cable or wireless (Bluetooth, etc.). Upon the program upload the cap will start stimulating the skull with the vibration pattern defined by the user's program. Visually the pattern is seen either via an LED mesh or in the software by changing the colors of the vibrating nodes in the GUI as shown in FIG. 5.

The wiring of the vibrator motors 11 for programming of the VNS is also shown in FIG. 5. The solid line 71 represents negative wire and the dot line 72 represents the positive wire. As is shown in FIG. 5, each vibrator 11 connected to each other with solid line 71 (negative wire) and all dotted lines 72 (positive wire) go to the PCU 20. With this kind of wiring the programming of each individual vibrator 11 is possible with helps of PCU 20 that programmed by a PC 12 through a USB connection 13 or by a handheld mobile phone 15 through Wireless connections 16.

The wiring for all embodiments of the present invention is the same as shown the FIG. 5. Vibrator motors 11 are connected in a series circuit; in a series circuit, the current through each of the vibrator motor is the same, and the voltage across the circuit is the sum of the voltages across each vibrator motor.

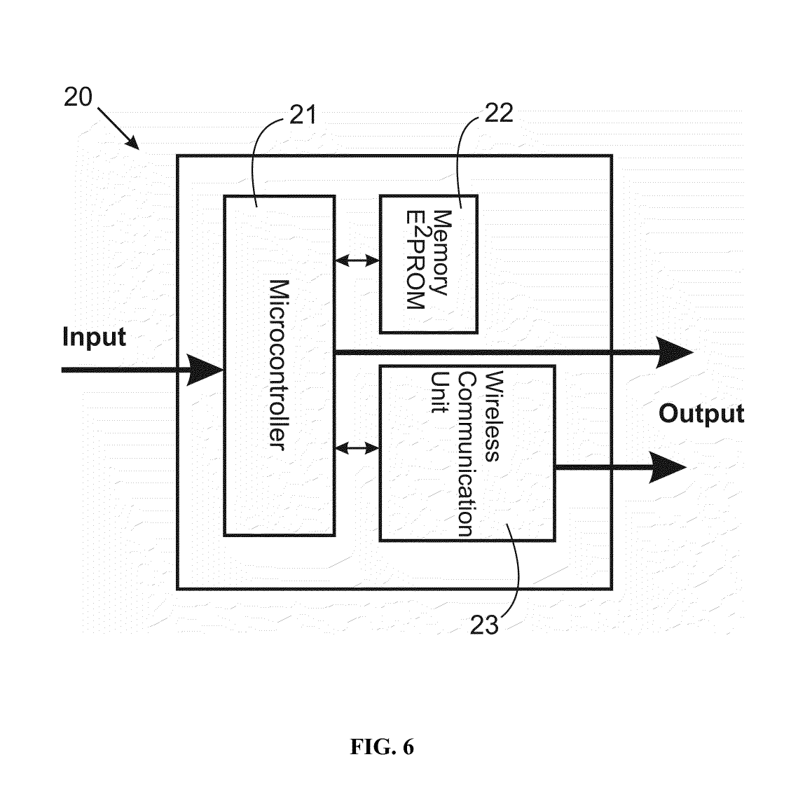

Schematic of the PCU 20 is shown in FIG. 6. The pattern of vibration is also generated and controlled by program(s) uploaded to the PCU 20 by the user. All necessary input data could go to Microcontroller 21. Microcontroller 21 is responsible for gathering data of all vibrators and analyzes data and sends the required commands to the vibrators.

Electrically Erasable Programmable Read-Only Memory (E²PROM) 22 is also utilized in the PCU 20 to store information such as device configuration. E²PROM is a type of non-volatile memory used in computers and other electronic devices to store small amounts of data that must be saved when power is removed. Wireless communication unit such as Bluetooth 23 is also designed in PCU 20 to communicate with computer or mobile device.

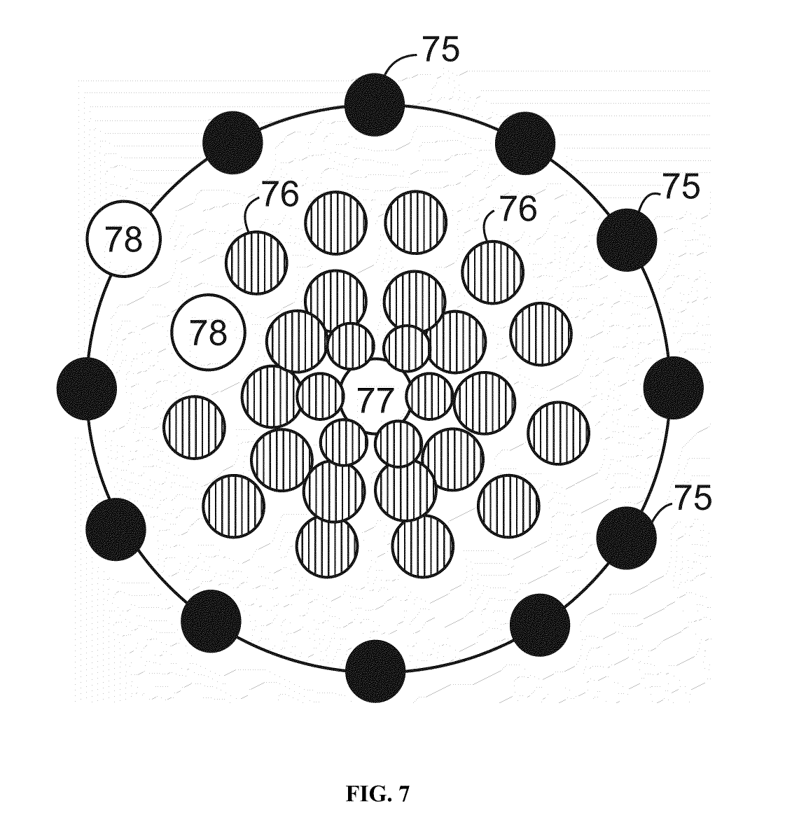

When the cap is worn by the user, the vibrators apply a vibration pattern on the scalp. FIG. 7 illustrates a pre-programmed pattern designed to relieve pain. Each circle in FIG. 7 represents a vibrator motor. In this pattern, the high intensity vibratory stimulation starts from the “no pain” shown with solid vibrators 75, with no vibration or minimized vibration at the “center of the pain” which is shown with circle 77. Over certain period of time (duration of treatment) suitable to the recipient's level of pain and comfort, vibration increases in circular wave motions towards the center, and eventually a maximum intensity vibratory stimulation is applied at the center of the pain 77.

One of the objectives of the present device is to identify a pattern that best suits a particular patient and stimulate the pain area gently and according to the patient's condition. Patient can define the “no pain” zone 75 and the “center of pain” 77 by putting pressure on those areas to be picked up by pressure sensors 78 and define them through the interface/app/software working in tandem with the mesh to apply the vibration patterns. The central vibrators 76 which are located in between the center of pain area 77 and the no pain area 75 are programmed to apply smooth vibratory stimulation to the pain site.

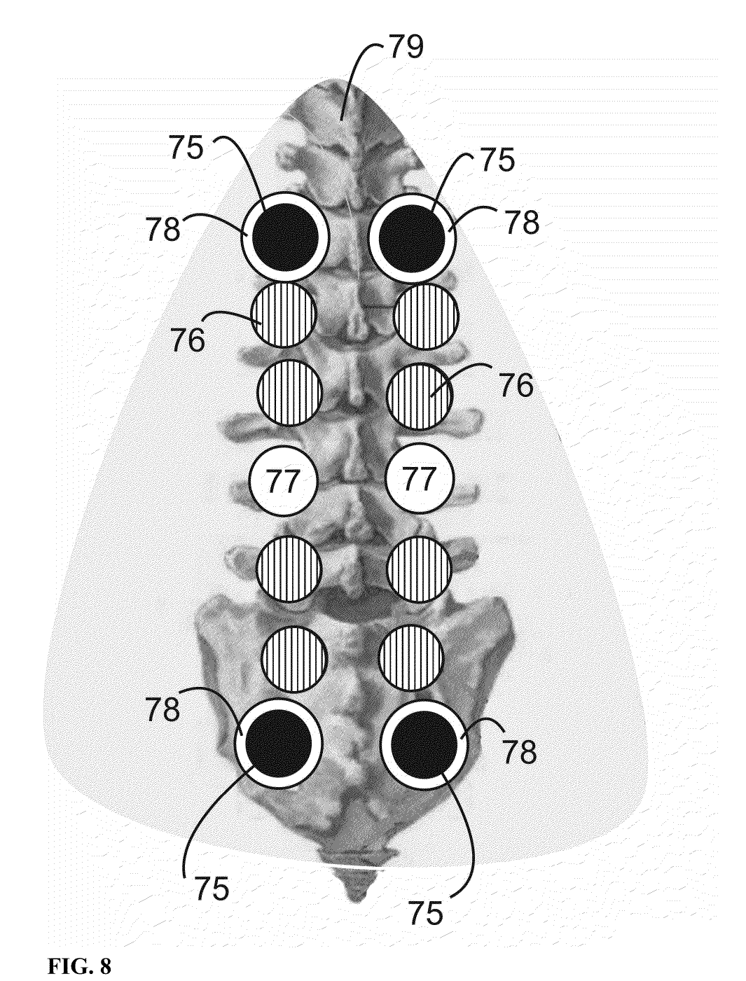

The same concept is applied to other forms of garments and patches including a patch for the back pain. FIG. 8 shows a preprogrammed pattern to be used with a VNS patch on the spinal column 79. Each circle represents a vibrator motor. Patient can define the “no pain” area 75 and the center of pain 77 by putting pressure on those areas to be picked up by pressure sensors 78 or graphically via GUI in the mobile app or PC, and define their vibration characteristics.

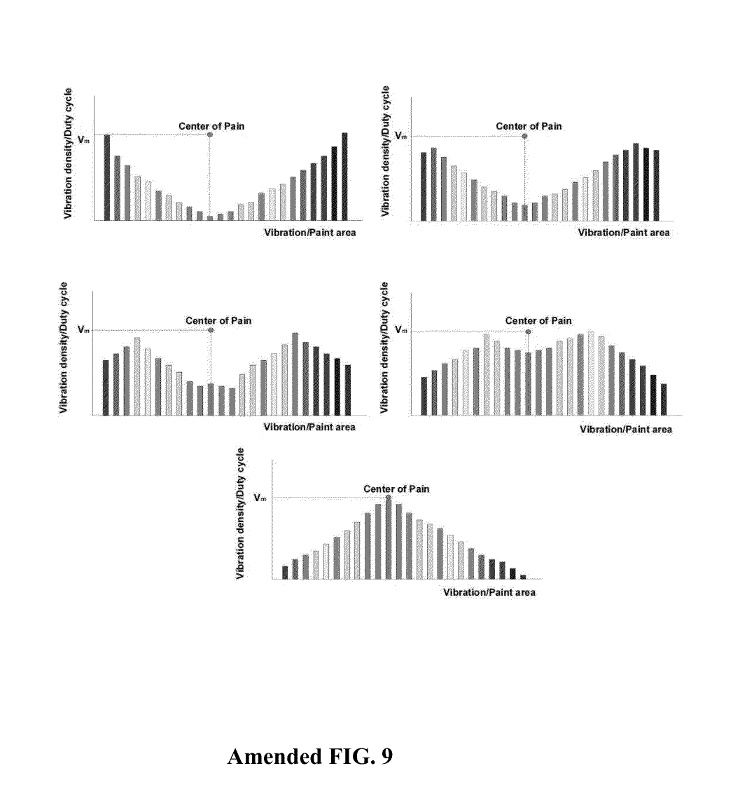

FIG. 9 shows the vibration intensity versus pain area during the treatment. The high intensity vibratory stimulations start from the “no pain” area and no vibration or minimized vibration is applied at the “center of pain”. The vibration patterns could cycle or repeat during the treatment.

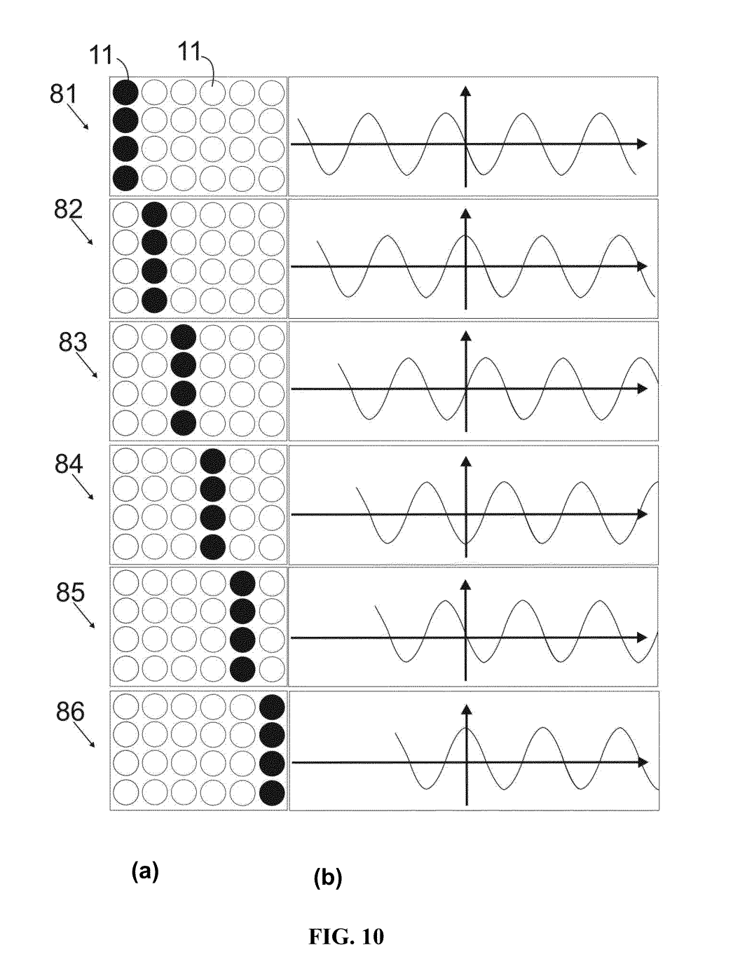

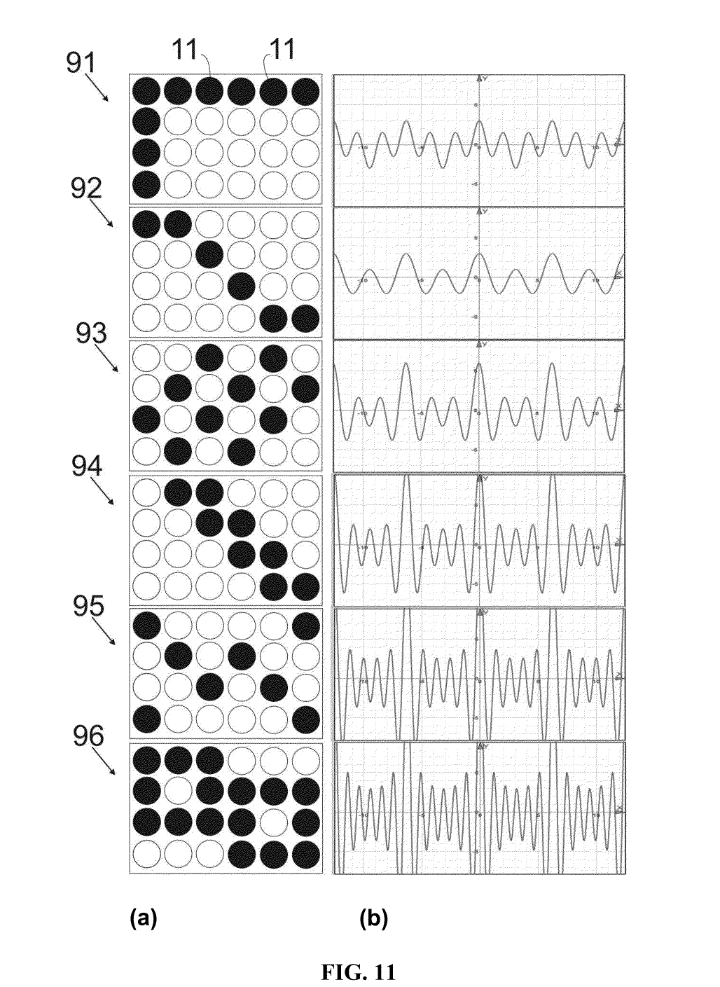

FIGS. 10 and 11 are provided to illustrate the functionality of the present device. FIG. 10 shows a vibration pattern in an array of 4×6 vibrators. In this pattern, 4 vertical vibrators are activated at the same time, each providing a sinusoidal vibration, as shown in FIG. 10-b. The pattern comprises of active vibrations as shown in 81 to 86. The first 4 vibrators vibrate for a set period, and the vibration shifts to the 4 vibrators in the next column. The same is repeated for all columns back and forth until the pain is relieved. If the pain is not relieved after a preset period, the patterns of vibration are changed. FIG. 10 (b) illustrates the form of the vibration that the user may feel. In this pattern, since all vibrators are in sync, the shift in the location of the vibration does not change the form of vibration.

FIG. 11 illustrates several vibration patterns 91-96, in which the frequency and amplitude of each vibrator is slightly altered. Therefore, the user feels the sum of several vibrators each having a periodic oscillation. This sum can be represented as f(t)=Σₙ₌₁^{N}aₙ sin(nωt+φ), where N represents the number of the vibrators, aₙ is the amplitude of a vibrator n, ω is its frequency of vibration and φ is its phase difference with respect to the first vibrator, and t is time. A random number generator installed in the system provides different values for the vibration amplitude, vibration frequency, and phase shift for each of the vibrators. The certain limiting numbers are preprogrammed to limit the range of the values of each of the parameters. FIG. 11 (b) represents the vibration intensity for the patterns 91-96 in FIG. 11 (a). The user identifies the pattern that is more effective in reducing his/her pain.

The vibration patterns can also be coupled with other devices. For instance, the VNS can be coupled with a game or a Virtual reality system to provide vibration coupled with such system. The present VNS can also receive a music in which the vibratos will operate in sync with the music beats. The VNS can also be coupled with a motor enhancing device to indicate certain movement or reactions required by a user. The VNS can also be coupled with PC or mobile phones to provide tactile communications through an app on PC or smart phones.

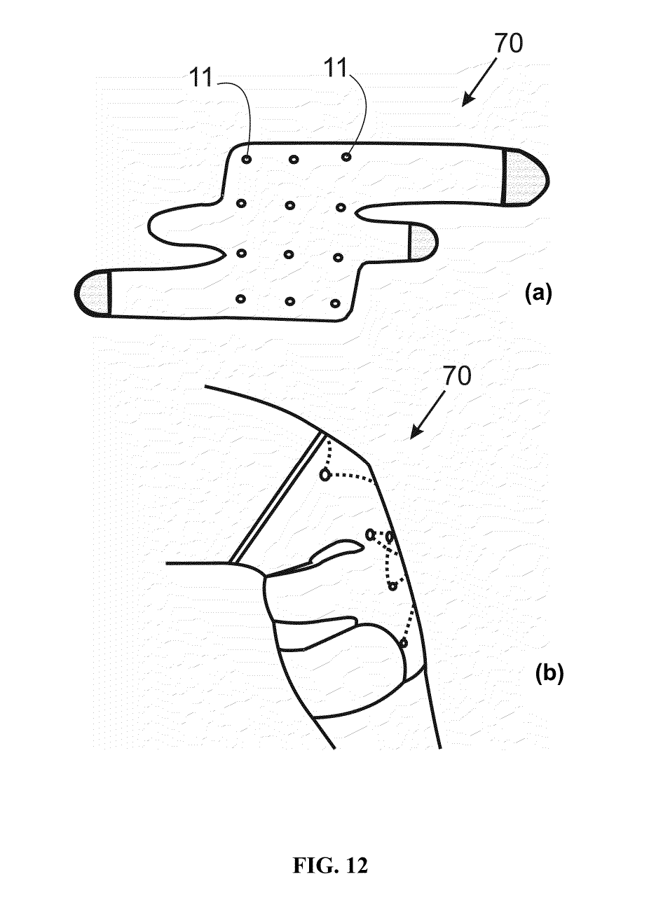

Another embodiment of the present invention is shown in FIG. 12 as VNS knee pad 70 with small vibrators 11. The small vibrators 11 vibrate at small amplitudes, resulting in minimal discomfort to the user. A wide range of patters can be applied by a user to obtain the pattern that best relieves the pain.

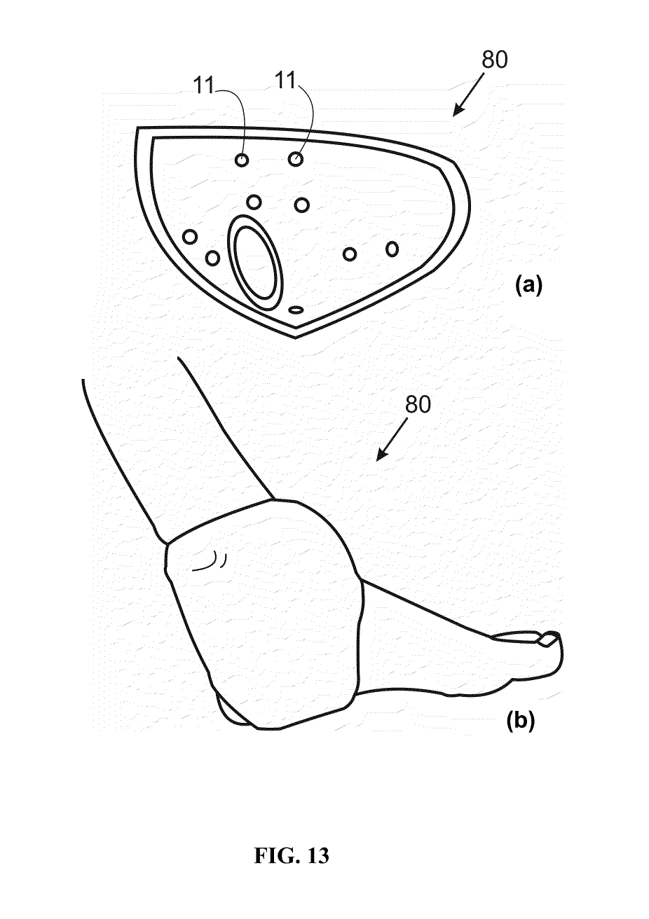

Another embodiment of the present invention is shown in FIG. 13 as VNS ankle brace 80 with small vibrators 11. A wide range of patters can be applied by a user to obtain the pattern that best relieves the pain. Because the device is light and portable, it can be used anywhere and anytime even when user is asleep.

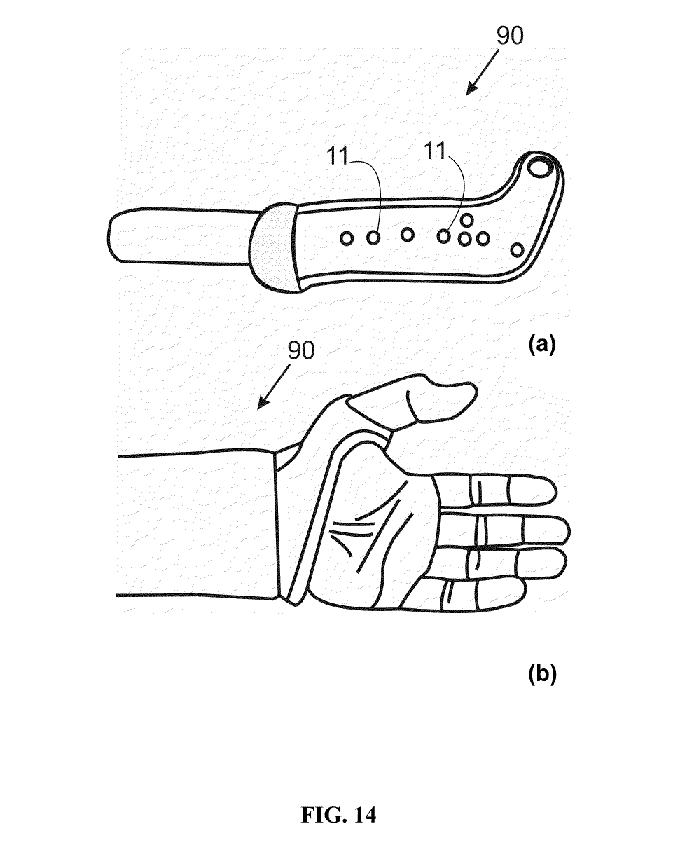

Another embodiment of the present invention is shown in FIG. 14 as VNS wrist pad 90 with small vibrators 11. Again, a wide range of patters can be applied by a user to obtain the pattern that best relieves the pain. Then that pattern is selected for future use.

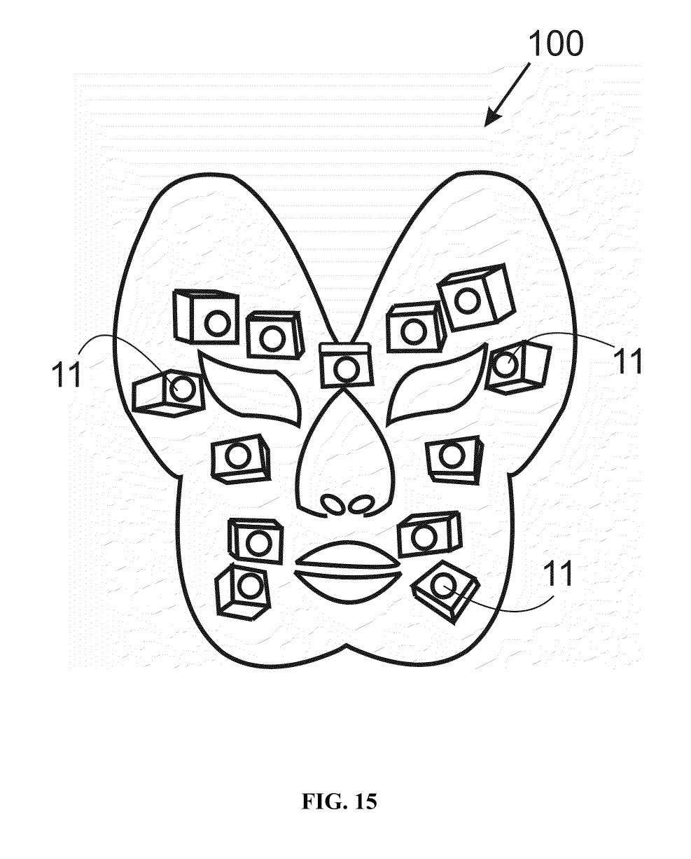

Another embodiment of the present invention is shown in FIG. 15 as VNS facial mask 100 with small vibrators 11. By finding the pattern that best fits a user, a relaxing facial vibration is generated. Vibratory stimulations could be applied to Temporal, Zygomatic, Buccal and Mandibular facial nerves.

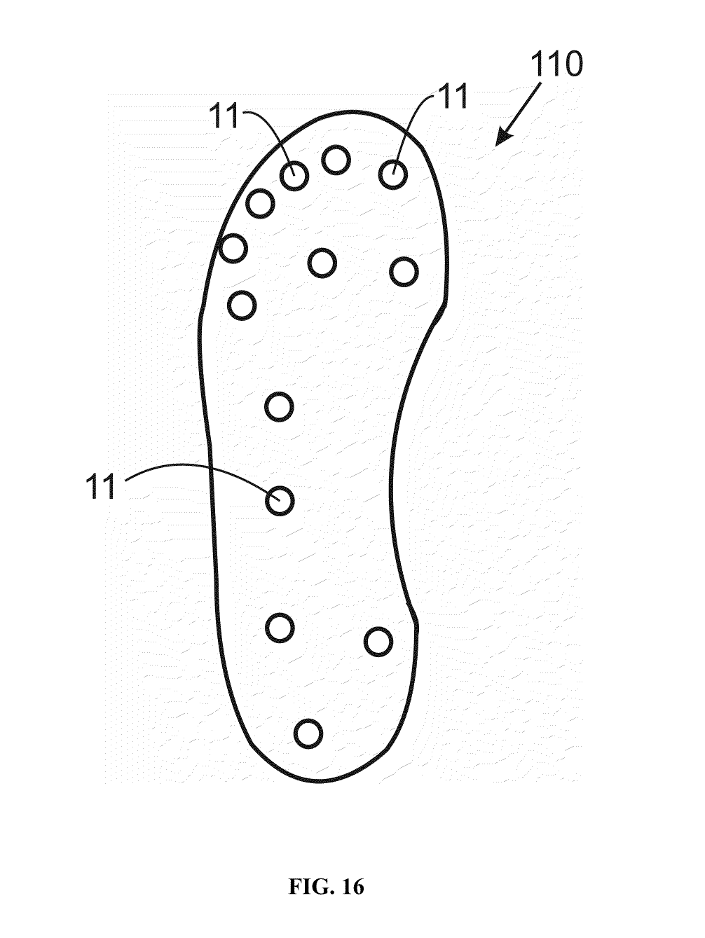

Another embodiment of the present invention is shown in FIG. 16 as VNS insole 110 with small vibrators 11. Because the VNS insole 110 is compact in design it can be fitted in any kind of shoes. Walking with VNS insole 110 can reduce foot pain and allow for long hours of standing, walks or hiking.

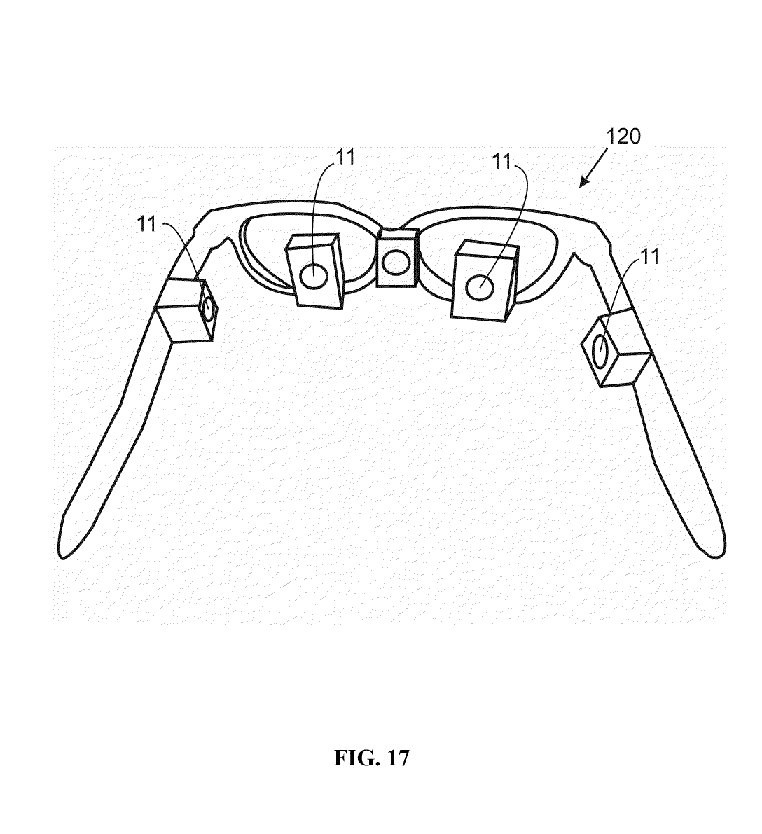

Another embodiment of the present invention is shown in FIG. 17 as VNS glasses 120 with small vibrators 11. The VNS glasses 120 can also relieve certain types of headaches.

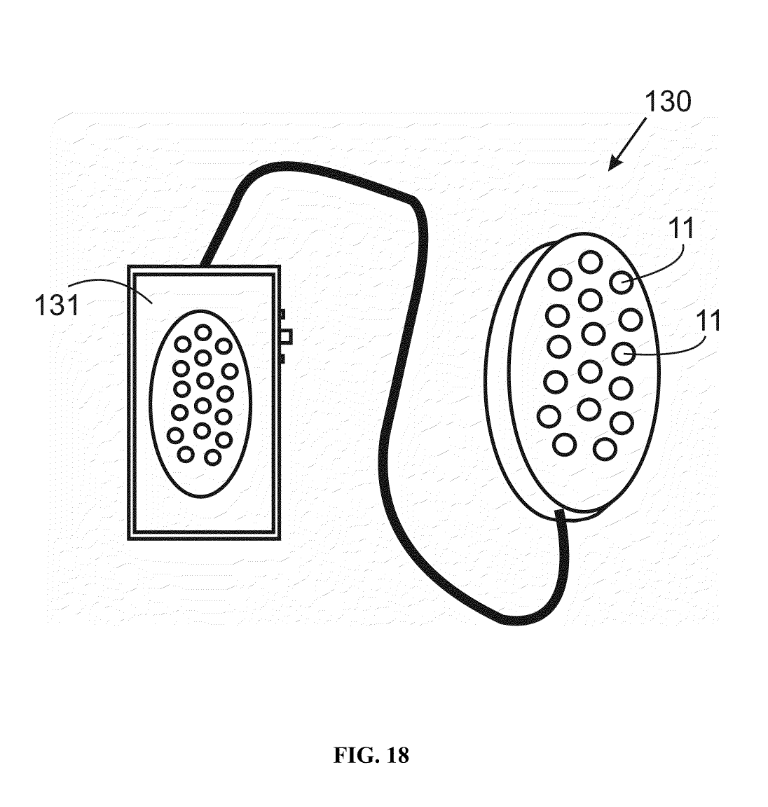

Another embodiment of the present invention is shown in FIG. 18 as VNS cushion pad 130 with small vibrators 11. The VNS cushion pad 130 can be located on different part of a body. As shown in FIG. 15, there is a controller 131 for this device that is used to change the pattern of vibration.

The present invention also envisages the following embodiments where the Programmable Vibration Mesh (using miniature DC motors as vibration nodes in a programmable mesh) is used to stimulate or massage human body parts by vibration with desired or specific patterns in forms of (a) wearable objects such as neck pad, belt, shirt, shorts, pants, gloves, sox, shoes, therapeutic arm and calf band, as well as toys for adult and children; and (b) mattress (pressure wound), pillow, cushion and blanket.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A vibratory neural stimulation (VNS) system that applies vibration to a desired region of a human body comprising:
a. plurality of miniature vibration disks installed in a flexible material forming a vibration mesh, wherein said vibration disks provide low amplitude vibration to allow a user to use the system for an extensive period of time;
b. a programmable control unit (PCU), wherein said programmable control unit is connected to each vibrator either by wire or wirelessly and it controls the vibration frequency and amplitude, and the period of activation of each said vibration disk;
c. a user interface software on a PC or a hand held device or an android phone/iPhone to control the operation of each said vibration disk; and
d. said software having vibration patterns to activate said vibration mesh to relieve pain.

2. The vibratory neural stimulation system of claim 1, wherein said vibration patterns comprise of patterns represented by Σₙ₌₁^{N}aₙ sin(nωt+φ), where N represents the number of the vibrators, aₙ is the amplitude of a vibrator n, ω is its frequency of vibration and φ is its phase.

3. The vibratory neural stimulation system of claim 2, wherein a random number generator provides the amplitude, frequency and phase of each said vibrator.

4. The vibratory neural stimulation system of claim 1, wherein each said vibrator further having a sensor to identify said vibrator by touching or applying a pressure on the sensor.

5. The vibratory neural stimulation system of claim 1, wherein each said vibration disk being controlled individually by said PCU.

6. The vibratory neural stimulation system of claim 1, wherein said user interface being selected from the group consisting of (i) a software which is installed on a personal computer, (ii) an application which is installed on an android mobile, (iii) an application which is installed on an iPhone, and (iv) a handheld device designed for specific pattern.

7. The vibratory neural stimulation system of claim 1, wherein said programmable control unit comprising: (a) a microcontroller responsible for gathering data of all said vibration disk and analyzing said data and sending command to the vibration disk; (b) a memory to store said data of all said vibration disk; and (c) a wireless communication unit to communicate with a personal computer or a mobile device.

8. The vibratory neural stimulation system of claim 1, wherein said VNS system being installed in a cap.

9. The vibratory neural stimulation system of claim 1, wherein said VNS system being installed in a knee pad to stimulate patella and the tibial nerves.

10. The vibratory neural stimulation system of claim 1, wherein said VNS system being installed in an ankle brace.

11. The vibratory neural stimulation system of claim 1, wherein said VNS system being installed in a wrist wrap to stimulate ulnar, median and radial nerves.

12. The vibratory neural stimulation system of claim 1, wherein said VNS system being installed in a facial mask to stimulate temporal, zygomatic, buccal and mandibular facial nerves.

13. The vibratory neural stimulation system of claim 1, wherein said VNS system being installed in an insole.

14. The vibratory neural stimulation system of claim 1, wherein said VNS system being installed in a glasses.

15. The vibratory neural stimulation system of claim 1, wherein said VNS system being installed in a cushion pad.

16. The vibratory neural stimulation system of claim 1, wherein said VNS system being installed in a pain relief patch.

17. The method of relieving pain, said method comprising steps of:
a. arranging plurality of vibrators around the pain area, each said vibrator having a sensor that can identify the sensor by touching or applying a pressure on it;
b. providing a driver for each said vibrator;
c. providing vibration patterns around the pain area using a controller; and
d. identifying the more effective pattern to relieve pain from among the preprogrammed vibration patterns.

18. The method of claim 17, wherein said vibration pattern being selected from a set of preprogrammed vibration patterns provided by the controller.

19. The method of claim 17, wherein said vibration pattern being defined by user by pressing on the desired vibrator or selecting on a GUI on a mobile phone app or PC.

20. The method of claim 17, wherein said pattern comprising steps of applying high intensity vibration to the area having no pain and applying no vibration or minimized vibration to the area having pain; continuously reducing the vibration intersecting in the no pain area while increasing the vibration intensity in the pain area; and repeating and cycling said vibration intensities.
